(19) United States
(12) Patent Application Publication
(10) Pub. No.: US 2025/0342040 A1
(43) Pub. Date: Nov. 6, 2025

(54) ELECTRONIC DEVICE, METHOD, AND COMPUTER-READABLE STORAGE MEDIUM FOR EXECUTING EACH OF PLURALITY OF THREADS THROUGH AT LEAST ONE CLUSTER

(71) Applicant: Samsung Electronics Co., Ltd., Suwon-si, (KR)

(72) Inventor: Unsang PARK, Suwon-si, (KR)

(21) Appl. No.: 19/265,753

(22) Filed: Jul. 10, 2025

Related U.S. Application Data
(63) Continuation of application No. PCT/KR2024/003754, filed on Mar. 26, 2024.

(30) Foreign Application Priority Data
Mar. 27, 2023 (KR) 10-2023-0039711
Apr. 25, 2023 (KR) 10-2023-0053959

(51) Int. Cl. G06F 9/38; G06F 9/30

(52) U.S. Cl. CPC G06F 9/3851; G06F 9/3009

(57) ABSTRACT

An electronic device may comprise: a first cluster including one or more cores driven in a first frequency range; and a second cluster including one or more cores having the maximum frequency less than the maximum frequency in the first frequency range. The electronic device may execute a first thread from among a plurality of threads using the first cluster. The electronic device may identify, based on executing the first thread, a call event requiring execution of a second thread for the execution of the first thread. The electronic device may at least temporarily stop executing the first thread using the first cluster, based on identifying the call event. The electronic device may execute, through the first cluster, the second thread corresponding to the second cluster.

### CROSS-REFERENCE TO RELATED APPLICATIONS

This application is a continuation of International Application No. PCT/KR2024/003754 designating the United States, filed on Mar. 26, 2024, in the Korean Intellectual Property Receiving Office and claiming priority to Korean Patent Application Nos. 10-2023-0039711, filed on Mar. 27, 2023, and 10-2023-0053959, filed on Apr. 25, 2023, in the Korean Intellectual Property Office, the disclosures of each of which are incorporated by reference herein in their entireties.

### BACKGROUND

### Field

The disclosure relates to an electronic device, a method, and a computer-readable storage medium for executing each of a plurality of threads through at least one cluster.

### Description of Related Art

Recently, spread of various types of portable electronic devices such as a smartphone, a tablet PC, a wireless earphone, and/or a smart watch is expanding. This portable electronic device may include a processor (e.g., a central processing unit (CPU)). The electronic device may operate a plurality of clusters included in the processor based on various frequencies.

### SUMMARY

In an electronic device according to an example embodiment, the electronic device may comprise: memory comprising one or more storage media storing instructions, and at least one processor comprising a first cluster including one or more cores operating in a first frequency range, and a second cluster including one or more cores having a maximum frequency less than a maximum frequency of the first frequency range, wherein at least one processor, individually or collectively, may be configured to execute the instructions and to cause the electronic device to: based on identifying a first thread to be executed through the first cluster among a plurality of threads executed based on the processor, execute the first thread using the first cluster; based on executing the first thread using the first cluster, identify a call event requiring execution of a second thread for executing the first thread; based on identifying the call event for executing the second thread corresponding to the second cluster, refrain at least temporarily from executing the first thread using the first cluster; and execute the second thread corresponding to the second cluster through the first cluster.

In a method performed by an electronic device according to an example embodiment, the method may comprise: based on identifying a first thread to be executed through a first cluster among a plurality of threads executed based on a processor, executing the first thread using the first cluster; based on executing the first thread using the first cluster, identifying a call event requiring execution of a second thread for executing the first thread; based on identifying the call event for executing the second thread corresponding to a second cluster, refraining at least temporarily from executing the first thread using the first cluster; and executing the second thread corresponding to the second cluster through the first cluster.

In a non-transitory computer-readable storage medium storing one or more programs according to an example embodiment, the one or more programs may include instructions which, when executed by at least one processor, including processing circuitry, individually and/or collectively, of an electronic device cause the electronic device to: based on identifying a first thread to be executed through a first cluster among a plurality of threads executed based on the processor, execute the first thread using the first cluster; based on executing the first thread using the first cluster, identify a call event requiring execution of a second thread for executing the first thread; based on identifying the call event for executing the second thread corresponding to a second cluster, refrain at least temporarily from executing the first thread using the first cluster; and execute the second thread corresponding to the second cluster through the first cluster.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example of an electronic device in a network environment according to various embodiments;

FIG. 2 is a block diagram illustrating an example configuration of an electronic device according to various embodiments;

FIG. 3 is a diagram illustrating an example of components included in memory according to various embodiments;

FIG. 4 is a diagram illustrating an example operation in which an electronic device executes each of a plurality of threads using each of a plurality of clusters according to various embodiments;

FIG. 5 is a flowchart illustrating an example operation of an electronic device according to various embodiments;

FIG. 6 is a flowchart illustrating an example operation of an electronic device according to various embodiments;

FIG. 7 is a flowchart illustrating an example operation of an electronic device according to various embodiments;

FIG. 8 is a flowchart illustrating an example operation of an electronic device according to various embodiments;

FIG. 9 is a flowchart illustrating an example operation of an electronic device according to various embodiments; and

FIG. 10 is a flowchart illustrating an example operation of an electronic device according to various embodiments.

### DETAILED DESCRIPTION

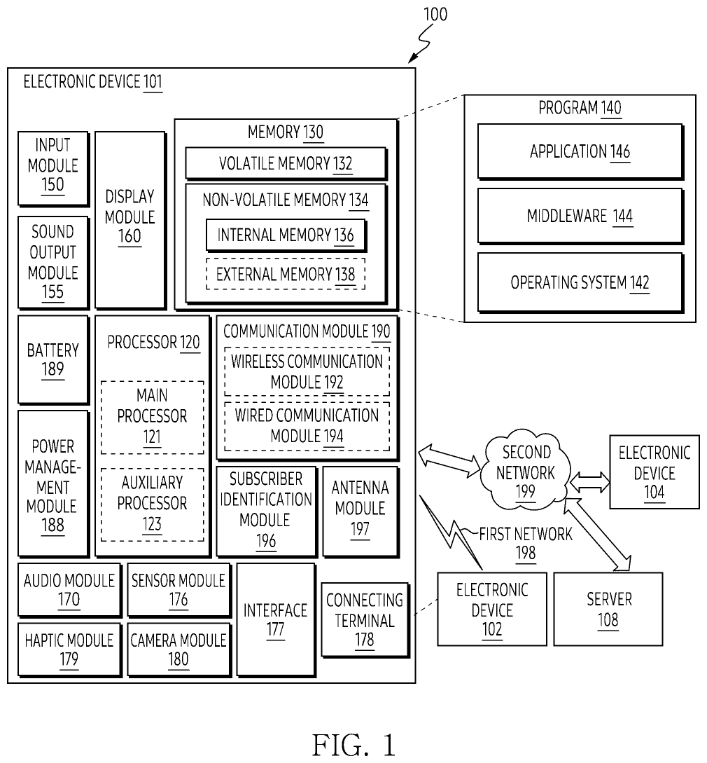

FIG. 1 is a block diagram illustrating an example electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function.

The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mm Wave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

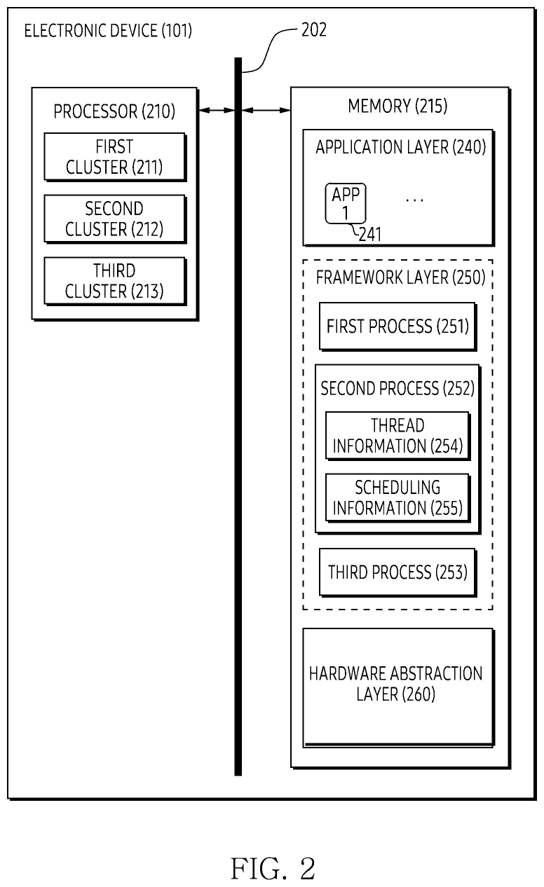

FIG. 2 is a block diagram illustrating an example configuration of an electronic device according to various embodiments. An electronic device 101 of FIG. 2 may include the electronic device 101 of FIG. 1. A processor (e.g., including processing circuitry) 210 of FIG. 2 may be substantially identical to the processor 120 of FIG. 1, or may include the processor 120 of FIG. 1. The electronic device 101 of FIG. 2 may include a terminal owned by a user. For example, the terminal may include a personal computer (PC) such as a laptop and a desktop, and a smart accessory such as a smartphone, a smart pad, a tablet PC, a smartwatch, and a head-mounted device (HMD).

Referring to FIG. 2, according to an embodiment, the electronic device 101 may include at least one of the processor 210, and/or memory 215. The processor 210, the memory 215, and a battery 189 may be electronically and/or operably coupled with each other by an electronical component such as a communication bus 202. Hereinafter, hardware being operably coupled may refer, for example, to a direct connection or an indirect connection between hardware being established by wire or wirelessly so that second hardware is controlled by first hardware among the hardware. Although illustrated in different blocks, the disclosure is not limited thereto. A portion of the hardware of FIG. 2 may be included in a single integrated circuit such as a system on a chip (SoC). A type and/or the number of the hardware included in the electronic device 101 is not limited as illustrated in FIG. 2. For example, the electronic device 101 may include only a portion of the hardware illustrated in FIG. 2.

According to an embodiment, the electronic device 101 may include the hardware for processing data based on one or more instructions. The hardware for processing the data may include the processor 210. For example, the hardware for processing the data may include an arithmetic and logic unit (ALU), a floating point unit (FPU), a field programmable gate array (FPGA), a central processing unit (CPU), and/or an application processor (AP). The processor 210 may have a structure of a single-core processor, or have a structure of a multi-core processor such as a dual core, a quad core, a hexa core, or an octa core. The processor 210 may include the processor 120 of FIG. 1. Thus, the processor 210 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

For example, the processor 210 of the electronic device 101 may include one or more clusters 211, 212, and 213 including one or more cores. The electronic device 101 may transmit data (e.g., scheduling information 255) obtained from memory 130 to one or more cores. The electronic device 101 may process at least one process (or a thread) based on each of the one or more cores using the data.

For example, a first cluster 211 may include cores operating in a first frequency range having a first maximum frequency. The second cluster 212 may include cores operating in a second frequency range having a second maximum frequency less than the first maximum frequency. A third cluster 213 may include cores operating in a third frequency range having a third maximum frequency less than the second maximum frequency.

For example, the one or more clusters 211, 212, and 213 are not limited as illustrated in FIG. 2. The one or more clusters 211, 212, and 213 may further include the first cluster 211 to an Nth core. For example, each of the one or more clusters 211, 212, and 213 may include cores with different maximum frequencies. The cores with different maximum frequencies may operate in different frequency ranges.

For example, the first cluster 211 may operate in the first frequency range having the first maximum frequency. The first cluster 211 may be referred to as a prime core (or a prime cluster) in terms of operating based on the first maximum frequency relatively higher than the maximum frequency corresponding to another cluster (e.g., the second cluster 212, and the third cluster 213).

For example, the second cluster 212 may operate in the second frequency range having the second maximum frequency. The second cluster 212 may be referred to as a big cluster in terms of operating based on the second maximum frequency relatively lower than the first maximum frequency.

For example, the third cluster 213 may operate in the third frequency range having the third maximum frequency. The third cluster 213 may be referred to as a little cluster or an efficient cluster in terms of operating based on the third maximum frequency relatively lower than the maximum frequency of another cluster (e.g., the first cluster 211 or the second cluster 212). However, the disclosure is not limited to the above. For example, when the first cluster 211 is referred to as a big cluster, the second cluster 212 may be referred to as a performance cluster or a middle cluster.

According to an embodiment, the memory 215 of the electronic device 101 may include a hardware component for storing data and/or instruction input to and/or output from the processor 120 of the electronic device 101. For example, the memory 215 may include volatile memory (e.g., the volatile memory 132 of FIG. 1) such as random-access memory (RAM), and/or non-volatile memory (e.g., the non-volatile memory 134 of FIG. 1) such as read-only memory (ROM). For example, the volatile memory may include at least one of dynamic RAM (DRAM), static RAM (SRAM), Cache RAM, and pseudo SRAM (PSRAM). For example, the non-volatile memory may include at least one of programmable ROM (PROM), erasable PROM (EPROM), electrically erasable PROM (EEPROM), flash memory, a hard disk, a compact disk, a solid state drive (SSD), and an embedded multi media card (eMMC). The memory 215 may include the memory 130 of FIG. 1.

For example, in the memory 215 of the electronic device 101, one or more instructions (or commands) indicating a calculation and/or an operation to be performed by the processor 210 of the electronic device 101 on data may be stored. A set of one or more instructions may be referred to as a program, firmware, an operating system, a process, a routine, a sub-routine, and/or an application. Hereinafter, an application being installed in an electronic device (e.g., the electronic device 101) may refer, for example, to one or more instructions provided in a shape of the application being stored in the memory 215, and the one or more applications are stored in a format (e.g., a file having an extension preset by the operating system of the electronic device 101) that is executable by a processor of the electronic device.

For example, programs installed in the electronic device 101 may be classified as any one layer of different layers including an application layer 240, a framework layer 250, and/or a hardware abstraction layer (HAL) 260 based on a target. For example, in the hardware abstraction layer 260, programs (e.g., a driver) designed to target hardware (e.g., the processor 210 and/or the memory 215) of the electronic device 101 may be classified. For example, in the framework layer 250, programs (e.g., a first process 251, a second process 252, and/or a third process 253) designed to target at least one of the hardware abstraction layer 260 and/or the application layer 240 may be classified. Programs classified as the framework layer 250 may provide an executable application programming interface (API) based on another program.

For example, in the application layer 240, a program designed to target a user controlling the electronic device 101 may be classified. Referring to FIG. 2, as an example of programs classified into the application layer 240, a first application 241 is illustrated, but an embodiment is not limited thereto. For example, the programs (e.g., application software) classified as the application layer 240 may cause execution of a function supported by programs classified as the framework layer 250, by calling the API.

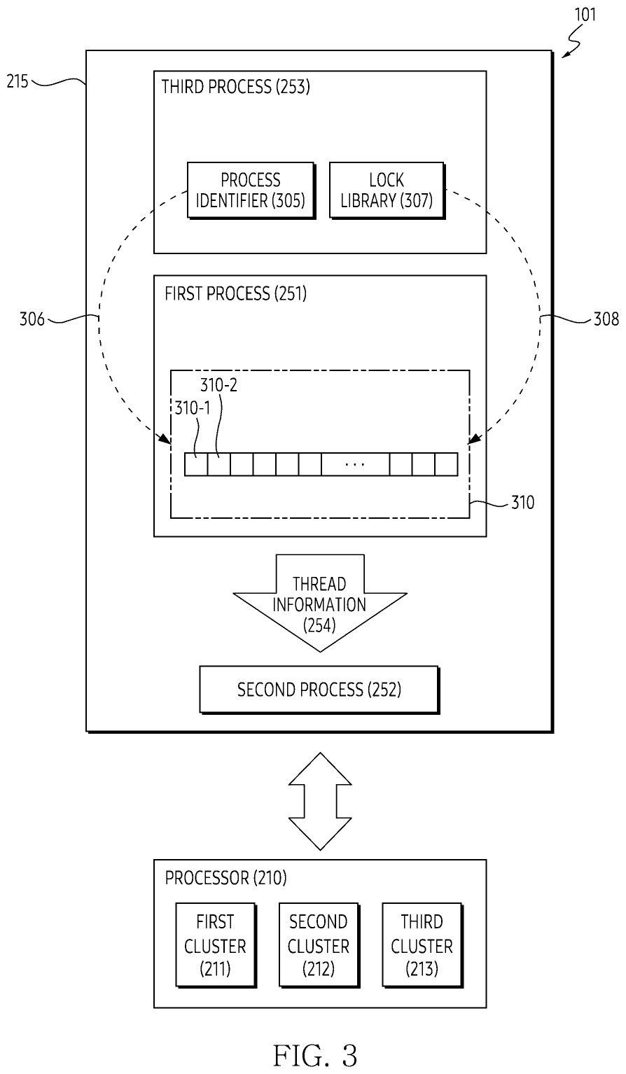

For example, the electronic device 101 may store data sets (e.g., thread information 254) corresponding to one or more threads in a memory area (e.g., a stack area to be described in greater detail below with reference to FIG. 3) corresponding to the first process 251 based on execution of the first process 251. The electronic device 101 may store the data sets corresponding to the one or more threads to be processed through the first cluster 211 in the memory area using the second process 252. The electronic device 101 may execute the one or more threads based on a maximum frequency corresponding to the first cluster 211. The one or more threads to be processed through the first cluster 211 may be related to execution of at least one application (e.g., the first application 241) stored in the memory. However, the disclosure is not limited thereto. For example, the electronic device 101 may store the data sets in the memory area based

on an order of the one or more threads. The electronic device 101 may execute each of the one or more threads through the first cluster 211 using the second process 252 based on an order of the data sets stored in the memory area. The memory area corresponding to the first process 251 may be an area (e.g., a kernel area) accessible by the second process 252. The electronic device 101 may execute each of the one or more threads corresponding to each of the data sets using the second process 252 based on storing the data sets stored in the memory area using the first process 251. The one or more threads may be occupied in the memory area corresponding to the first process 251. However, the disclosure is not limited thereto.

For example, based on execution of the second process 252, the electronic device 101 may execute each of the one or more programs stored in the electronic device 101 through each of the one or more clusters 211, 212, and 213 included in the processor 210. The electronic device 101 may initiate or refrain execution of each of the one or more programs mapped to each of the one or more clusters 211, 212, and 213 using the scheduling information 255. The second process 252 may be referred to as a kernel scheduler in terms of identifying an order for executing each of the one or more programs.

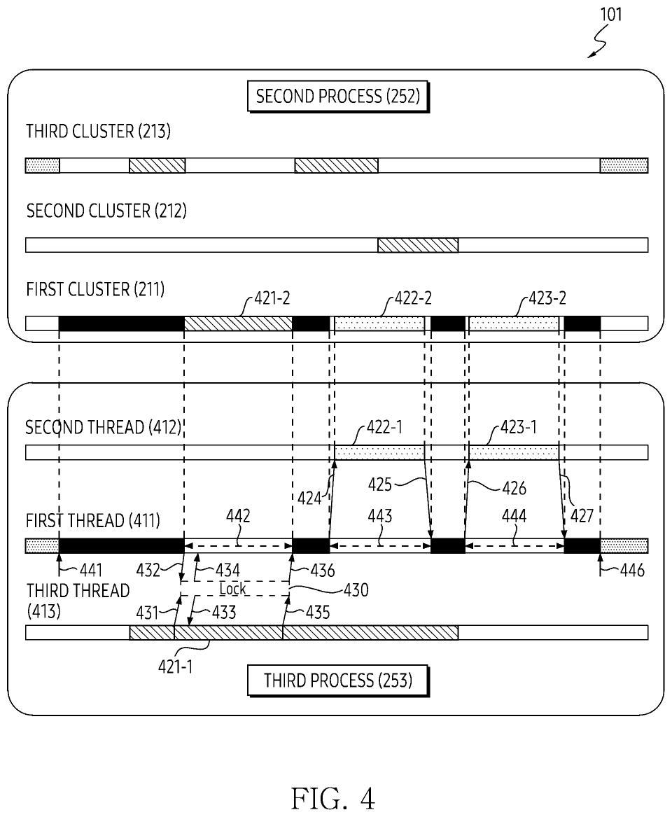

For example, the electronic device 101 may execute the one or more threads corresponding to the thread information 254 based on the first cluster 211 using the thread information 254 stored based on the execution of the first process 251 through the second process 252. An operation in which the electronic device 101 executes the one or more threads based on the first cluster 211 will be described in greater detail below with reference to FIG. 4.

For example, the electronic device 101 may identify the one or more threads to be processed through the first cluster 211 based on execution of the third process 253. The third process 253 may refer, for example, to a system process and/or a service. For example, the one or more threads may be used to execute a program stored in the electronic device 101. The one or more threads may include the data sets to be processed while the processor 210 executes the third process 253. Each of the one or more threads may include identification information and/or cache data for being processed by the processor 210. Each of the one or more threads may be processed independently. Hereinafter, the one or more threads may be referred to as a program such as a process and/or an application which is processed by the processor 210 of the electronic device 101.

The electronic device 101 may obtain information for executing at least one of the one or more threads using the first cluster using the second process 252. Based on obtaining the information, the electronic device 101 may store a data set indicating the at least one thread corresponding to the information in the memory area using the first process 251. The electronic device 101 may execute the at least one thread through the first cluster 211 based on the second process 252 using the data set stored in the memory area.

As described above, according to an embodiment, the electronic device 101 may obtain the information on the at least one thread to be processed through the first cluster 211 while processing the one or more threads based on the scheduling information 255. The electronic device 101 may store the information on the at least one thread in the memory area assigned to the first process 251. The electronic device 101 may execute the at least one thread through the first cluster 211 using the second process 252. Based on executing the at least one thread through the first cluster 211, the electronic device 101 may more quickly process an operation related to the at least one thread (e.g., operation of initiating execution of an application).

FIG. 3 is a diagram illustrating an example of components included in memory according to various embodiments. An electronic device 101 of FIG. 3 may include the electronic device 101 of FIGS. 1 and 2. Referring to FIG. 3, an example of an operation in which the electronic device 101 processes data generated by processes stored in memory 215 is illustrated.

According to an embodiment, the electronic device 101 may obtain data to be processed by a first process 251 using a third process 253. For example, the electronic device 101 may obtain the data to be processed by the first process 251 using a process identifier 305 and/or a lock library 307 in the third process 253.

For example, the electronic device 101 may generate information 306 for processing one or more threads through a first cluster 211 using the process identifier 305. An operation in which the electronic device 101 executes each of the one or more threads through the first cluster 211 independently of scheduling information corresponding to each of the one or more threads may be referred to as a boosting operation in terms of processing the one or more threads more quickly.

For example, the information 306 for processing the one or more threads through the first cluster 211 may include identification information, cache data, and/or starting time point for the one or more threads. The electronic device 101 may initiate execution of the at least one thread through the first cluster 211 based on processing the information 306 by the first process 251. The information 306 may include information for executing at least one of the plurality of threads using the first cluster 211. The information 306 may be generated in a form of a class, and/or a java native interface (JNI) library. However, the disclosure is not limited thereto.

For example, the electronic device 101 may store a data set on a thread indicated by the information 306 in a stack area 310 based on processing the information 306 using the first process 251. The electronic device 101 may store in the stack area 310 based on an order of the data set on the thread. The stack area 310 may be memory area assigned to the first process 251. The stack area 310 may be an area accessible by another second process 252 distinct from the first process 251. The electronic device 101 may process the data set generated from the first process 251 based on the second process 252 using the stack area 310. For example, the electronic device 101 may obtain information 308 for controlling processing of a thread for processing another thread while processing the thread using the lock library 307. The information 308 may include data related to a remote procedure call (e.g., a binder call), and/or a lock event. The electronic device 101 may store the data set indicated by the information 308 in the stack area 310. Based on processing the data set, the electronic device 101 may identify whether the processing-controlled thread is related to at least one thread executed through the first cluster 211 indicated by the information 306. For example, the remote procedure call (e.g., a binder call) may be identified based on calling execution of another thread to execute the thread. For example, the lock event may be identified based on the data to be processed for the execution of the thread during a preset time period being occupied for the execution of another thread.

For example, the electronic device 101 may identify the order of the data sets stored in the stack area 310. The electronic device 101 may identify the order of data sets based on identifying an event (e.g., an event that requires the execution of another thread for the execution of a thread to be described in greater detail below with reference to FIG. 4) that occurred between the one or more threads using the lock library 307. The electronic device 101 may identify the order of the data sets based on pushing (or storing) or popping (or releasing) each of the data sets in the stack area 310. After storing a first data set corresponding to a first thread in a first sub-area 310-1, the electronic device 101 may store a second data set corresponding to a second thread in a second sub-area 310-2. The electronic device 101 may release the second data set from the second sub-area 310-2 in order to pop (or release) the first data set. In other words, the electronic device 101 may first release (or pop) the last pushed data set.

For example, the electronic device 101 may transmit thread information 254 including the data sets on the one or more threads stored in the stack area 310 to the second process 252. The electronic device 101 may execute each of the one or more threads according to the order of the data sets through the first cluster 211, using the thread information 254, based on the execution of the second process 252.

For example, the electronic device 101 may obtain information from the third process 253 to refrain from processing the one or more threads through the first cluster 211. Based on obtaining the information, the electronic device 101 may refrain at least temporarily from executing the one or more threads through the first cluster 211 using the second process 252. The electronic device 101 may execute each of the one or more threads through at least one of the first cluster 211, the second cluster 212, and/or the third cluster 213 based on the scheduling information (e.g., the scheduling information 255 of FIG. 2) based on refraining temporarily the operation.

For example, the electronic device 101 may change a position of data corresponding to the one or more threads to execute the one or more threads through the first cluster 211. The electronic device 101 may identify the first thread corresponding to the second cluster 212 among the one or more threads. The first thread corresponding to the second cluster 212 may refer, for example, to the first thread executed through the second cluster 212. The electronic device 101 may store the data set on the first thread in the stack area 310 based on identifying the information (e.g., the information 306) for executing the first thread through the first cluster 211. The electronic device 101 may change the data on the first thread corresponding to the second cluster 212 to be executed through the first cluster 211 based on storing the data set in the stack area 310.

For example, while executing the first thread through the second cluster 212, the electronic device 101 may change the data indicating the execution of the first thread through the second cluster 212 based on identifying the information (e.g., the information 306). The electronic device 101 may change information (e.g., a range of data, and/or cache data) indicating the execution of the first thread through the second cluster 212 to be processed through the first cluster 211. An operation in which the electronic device 101 changes the second cluster 212 corresponding to the first thread to the first cluster 211 may be referred to as data migration. Hereinafter, the data migration may refer, for example, to assigning a thread to a core based on the highest frequency among one or more cores included in the first cluster 211.

Hereinafter, an example of an operation in which the electronic device 101 executes each of the one or more threads through the first cluster 211 based on identifying an event indicating an interaction between the one or more threads will be described in greater detail below with reference to FIG. 4.

FIG. 4 is a diagram illustrating an example operation in which an electronic device executes each of a plurality of threads using each of a plurality of clusters according to various embodiments. An electronic device 101 of FIG. 4 may include the electronic device 101 of FIGS. 1, 2 and 3 (which may be referred to as FIGS. 1 to 3). Referring to FIG. 4, an example indicating an execution state of one or more threads 411, 412, and 413 for the electronic device 101 according to various embodiments for processing, using a second process 252 is illustrated.

The electronic device 101 according to an embodiment may execute each of the one or more threads 411, 412, and 413 through each of one or more clusters 211, 212, and 213 based on scheduling information using the second process 252. The one or more threads 411, 412, and 413 may be related to execution of the third process 253. However, the disclosure is not limited thereto.

For example, the electronic device 101 may obtain data 441 for executing the first thread 411 through the first cluster 211, while executing the first thread 411 through the third cluster 213.

The data 441 may be obtained based on information 306 of FIG. 3. The data 441 may include information (e.g., the information 306 of FIG. 3) requesting the first thread 411 to be executed through the first cluster 211. For example, the electronic device 101 may transmit information on the first thread 411 to a first process 251 based on execution of a process identifier (e.g., the process identifier 305 of FIG. 3). The electronic device 101 may store the information on the first thread 411 in a stack area (e.g., the stack area 310 of FIG. 3) based on transmitting the information on the first thread 411 to the first process 251. The electronic device 101 may execute the first thread 411 based on the first cluster 211 using the second process 252 based on storing the information in the stack area. The electronic device 101 may migrate data related to execution of the first thread 411 to the first cluster 211 to execute the first thread 411 based on the first cluster 211. In an embodiment, executing the first thread 411 based on the first cluster 211 may be referred to as a boosting operation of the first thread 411.

For example, the electronic device 101 may execute the first thread 411 through the first cluster 211 in response to obtaining the data 441. The electronic device 101 may identify an event 430 (e.g., a lock event) requiring execution of the third thread 413 for the execution of the first thread 411 while executing the first thread 411 (or during the boosting of the first thread 411) through the first cluster 211. The event may be referred to as a call event in terms of calling execution of another thread for execution of a thread.

For example, the electronic device 101 may identify the event 430 based on the lock library 307 of FIG. 3 for identifying the event 430. The electronic device 101 may process information indicating the event 430 by the first process 251 based on execution of the lock library 307. As an example, based on processing the information indicating the event 430 by the first process 251, the electronic device 101 may identify whether the event 430 is related to at least one thread to be executed through the first cluster 211. However, the disclosure is not limited thereto.

For example, the event 430 may be identified based on the data to be processed for the execution of the first thread 411 during a time period 442 being occupied for the execution of the third thread 413. The event 430 may be identified based on the data being used for the execution of the third thread 413 before processing the data for executing the first thread 411. However, the disclosure is not limited thereto.

For example, the electronic device 101 may identify a signal 431 (or a signal requesting occupation of first data) indicating that first data to be processed for the execution of the first thread 411 is occupied while executing the third thread 413 based on the third cluster 213, using the scheduling information (e.g., the scheduling information 255 of FIG. 2). In case that there is no another thread occupying the first data, the electronic device 101 may obtain a permission signal 433 indicating that the first data is available for the execution of the third thread 413. While executing the third thread 413 using the first data, the electronic device 101 may block access to the first data for execution of the another thread. In terms of occupying the first data, the third thread 413 may be referred to as a lock owner for the event 430.

For example, after identifying the signal 431, the electronic device 101 may identify a signal 432 (or a signal requesting the occupation of the first data) for occupying the first data for the execution of the first thread 411. The electronic device 101 may identify that the first data is used for the execution of the third thread 413 based on identifying the signal 432. Based on identifying that the first data is used for the execution of the third thread 413, the electronic device 101 may identify a blocking signal 434 (or a signal indicating that access to the first data of the first thread 411 is blocked) requesting to refrain temporarily the execution of the first thread 411.

The electronic device 101 may refrain temporarily the execution of the first thread 411 using the first cluster 211 based on the identification of the signal 434. The electronic device 101 may refrain temporarily the execution of the first thread 411 during a time period 442 during which the first data is occupied for the execution of the third thread 413. Operations requiring access to the first data of the first thread 411 may be refrained temporarily during the time period 442 during which the third thread 413 occupies the first data. The time period 442 may include a time period from a generation time point of the signal 431 of the third thread 413 to a generation time point of a signal 435. The time period 442 may correspond to a range of data (e.g., shared resource) used for execution of a plurality of threads. The data range may be referred to as a critical section 421-1 from the perspective that each of the plurality of threads may not access the data range at the same time for the execution of the plurality of threads. In an embodiment, the critical section may refer to a portion of codes (or instructions) (or a portion of operations) of codes (or instructions) (or operations) of the threads that allow threads to access shared resource (or shared data) that are not allowed to access two or more threads simultaneously (or should not be accessed simultaneously).

For example, the electronic device 101 may identify whether the event 430 is related to the first thread 411 executed through the first cluster 211 based on identifying the event 430. The electronic device 101 may identify whether the data set for the first thread 411 stored in the stack area (e.g., the stack area 310 of FIG. 3) is identical to the first thread 411 whose execution is refrained temporarily during the time period 442.

For example, in case that the data set for the first thread 411 stored in the stack area and the first thread 411 whose execution is refrained temporarily during the time period 442 is identical, the electronic device 101 may store the data set corresponding to the third thread 413 in the stack area (e.g., the stack area 310 of FIG. 3). For example, in case that the data set for the first thread 411 is stored in a first sub-area (e.g., the first sub-area 310-1 of FIG. 3), the electronic device 101 may push the data set for the third thread 413 to a second sub-area (e.g., the second sub-area 310-2 of FIG. 3).

For example, the electronic device 101 may process thread information (e.g., the thread information 254 of FIG. 2) indicating the data set for the third thread 413 pushed to the second sub-area based on the second process 252. The electronic device 101 may execute the third thread 413 (or the critical area 421-1 of the third thread 413) through the first cluster 211 while the execution of the first thread 411 is refrained temporarily through the first cluster 211 (e.g., during the time period 442) using the second process 252. The electronic device 101 may wait for the execution of the first thread 411 during the time period 421-1 in which the third thread 413 is executed through the first cluster 211. The electronic device 101 may wait for execution of the operations requiring access to the first data of the first thread 411 during the time period 442 in which the third thread 413 occupies the first data (or during the critical area 421-1 of the third thread 413). As an example, the electronic device 101 may execute the third thread 413 through the first cluster 211 based on migrating data indicating the execution of the third thread 413 corresponding to the third cluster 213. The electronic device 101 may refrain at least temporarily the execution of the operations requiring access to the first data of the first thread 411 through the first cluster 211 while identifying a call event indicating that the third thread 413 occupies the first data. The electronic device 101 may execute the operations (or the critical zone 421-1) requiring access to the first data among operations of the third thread 413 corresponding to the third cluster 213 (or executed through the third cluster 213) while identifying the call event indicating that the third thread 413 occupies the first data, through the first cluster 211. For example, the operation in which the electronic device 101 executes the third thread 413 corresponding to the third cluster 213 (or executed through the third cluster 213) through the first cluster 211 may be referred to as a boosting operation of the third thread 413.

For example, the electronic device 101 may identify an event that initiates the execution of the first thread 411 while executing the third thread 413 through the first cluster 211. The event may refer, for example, to blocking of data 413 (e.g., a data range corresponding to the time period 442) processed for the execution of the third thread 413 being released. The electronic device 101 may obtain the signal 435 indicating release for a data range (e.g., a critical period corresponding to the time period 442) occupied for the execution of the third thread 413. Based on obtaining the signal 435, the electronic device 101 may obtain a signal 436 indicating that the execution of the first thread 411 refrained temporarily is initiated.

For example, the electronic device 101 may release the data set for the third thread 413 stored in the stack area (e.g., the stack area 310 of FIG. 3) from the stack area, using a first process (e.g., the first process 251 of FIG. 1) based on obtaining the signal 436 indicating that the execution of the first thread 411 is initiated. The electronic device 101 may initiate the execution of the first thread 411 through the first cluster 211 using the data set for the first thread 411 based on releasing the data set for the third thread 413 from the stack area. Based on executing the third thread 413 through the first cluster 211, the electronic device 101 may reduce waiting time for the execution of the first thread 411.

According to an embodiment, the electronic device 101 may identify an event (e.g., a remote procedure call, RPC) for calling another thread distinct from the first thread 411 while executing the first thread 411 through the first cluster 211. The electronic device 101 may identify the event based on obtaining a signal 424 indicating a call of the second thread 412 based on the execution of the first thread 411. The signal 424 may correspond to the remote procedure call (RPC). The signal 424 may be implemented in various formats according to an operating system of the electronic device 101. As an example, in case of an Android operating system, the signal 424 may be referred to as a binder call. The electronic device 101 may initiate execution of the second thread 412 based on identifying the signal 424. As an example, the event may be identified based on calling the execution of the second thread 412 through the execution of the first thread 411. As an example, the electronic device 101 may identify the event requiring data by the second thread 412 for the execution of the first thread 411. As an example, the electronic device 101 may obtain the signal 424 for calling the execution of the second thread 412 to use data obtained based on the execution of the second thread 412 for the execution of the first thread 411. However, the disclosure is not limited thereto. The signal 424 may include information indicating the signal 425 for synchronizing the first thread 411 and the second thread 412. The event may refer, for example, to the synchronous-based binder call in terms of synchronizing the execution of the first thread 411 and the execution of the second thread 412.

For example, the electronic device 101 may identify the signal 424 while executing the first thread 411 based on the first cluster 211 using the data set for the first thread 411 stored in the stack area (e.g., the stack area 310 of FIG. 3). The electronic device 101 may identify an event (e.g., the remote procedure call) for calling another thread. The electronic device 101 may identify whether the first thread 411 and the event are related based on identifying the event. The electronic device 101 may identify the first thread 411 related to the event by identifying the signal 424 for calling the execution of the second thread 412 based on the execution of the first thread 411. The first thread 411 may be referred to as a caller in terms of calling the second thread 412. In terms of receiving the call, the second thread 412 may be referred to as a callee.

For example, the electronic device 101 may release (or pop) the data set for the first thread 411 stored in the stack area (e.g., the stack area 310 of FIG. 3) from the stack area based on identifying the signal 424. The electronic device 101 may identify whether the second thread 412 matches the data set last stored in the stack area. In case that the second thread 412 matches the data set, the electronic device 101 may execute the second thread 412 through the first cluster 211 using the data set. For example, in case that the second thread 412 matches the data set, the electronic device 101 may push the data set for the released first thread 411 to the stack area (e.g., the first sub-area 310-1 of FIG. 3). After pushing the data set for the first thread 411, the electronic device 101 may push the data set for the second thread 412 to the stack area (e.g., the second sub-area 310-2 of FIG. 3). The electronic device 101 may execute the second thread 412 through the first cluster 211 based on the second process 252 using thread information (e.g., the thread information 254 of FIG. 2) on the stack area. For example, the electronic device 101 may migrate data for the second thread 412 to execute the second thread 412 through the first cluster 211. The electronic device 101 may transmit data (e.g., identification information of the second thread 412) for the second thread 412 to the first cluster 211. However, the disclosure is not limited thereto.

For example, the electronic device 101 may refrain temporarily the execution of the first thread 411 to execute the second thread 412 through the first cluster 211. The electronic device 101 may refrain temporarily the execution of the first thread 411 during a time period 443 during a time period 422-1 in which the second thread 412 is executed through the first cluster 211. The electronic device 101 may identify the signal 425 indicating that execution of the first thread 411 is initiated while executing the second thread 412 through the first cluster 211. The signal 425 may include a feedback signal or a return signal for the signal 424.

For example, the electronic device 101 may release the data set for the second thread 412 pushed to the stack area (e.g., the stack area 310 of FIG. 3) based on identifying the signal 425. Based on releasing the data set for the second thread 412, the electronic device 101 may identify the data set for the first thread 411 that has been pushed prior to the data set for the second thread 412. Based on identifying the data set for the first thread 411, the electronic device 101 may initiate the execution of the first thread 411 through the first cluster 211 using the second process 252.

According to an embodiment, the electronic device 101 may identify another event for executing a fourth thread (not illustrated) distinct from the second thread 412 among one or more threads based on executing the second thread 412 through the first cluster 211 in response to the signal 424. The other event may include a second remote procedure call distinct from the first remote procedure call identified based on the execution of the first thread 411.

For example, based on identifying the other event, the electronic device 101 may identify whether the fourth thread is identical to the first thread 411 indicated by the data set pushed to the stack area (e.g., the stack area 310 of FIG. 3), using the first process 251. The electronic device 101 may refrain at least temporarily from executing the second thread 412 in a state where the fourth thread and the first thread 411 are identical. The electronic device 101 may execute the first thread 411 through the first cluster 211 based on refrain temporarily from executing the second thread 412.

For example, the electronic device 101 may push the data set for the fourth thread (not illustrated) to the stack area after pushing the data set indicating the execution of the second thread 412 to the stack area in another state (e.g., a state where the fourth thread and the first thread 411 are not identical) distinct from a state where the fourth thread and the first thread 411 are identical. The electronic device 101 may execute the fourth thread through the first cluster 211 using the data set for the last pushed fourth thread.

According to an embodiment, in case that the execution of the first thread 411 is called based on the execution of another thread distinct from the first thread 411, the electronic device 101 may identify the signal 426 for initiating the execution of the second thread 412 while executing the first thread 411 through the first cluster 211. The signal 426 may refer, for example, to a return signal indicating that execution of the first thread 411 executed based on the remote procedure call is refrained temporarily. However, the disclosure is not limited thereto.

For example, the electronic device 101 may release a first data set for the first thread 411 in the stack area based on obtaining the signal 426. Based on releasing the first data set for the first thread 411, the electronic device 101 may identify whether a data set pushed prior to the first data set matches the second data set for the second thread 412. In case that the data set matches the second data set, the electronic device 101 may initiate the execution of the second thread 412 based on the first cluster 211, using the second process 252. However, the disclosure is not limited thereto. As an example, the electronic device 101 may store the second data set for the second thread 412 in the stack area (e.g., the stack area 310 of FIG. 3) independently of releasing the first data set for the first thread 411. As an example, the electronic device 101 may wait for the execution of the first thread 411 during a time period 444, based on executing the second thread 412. However, the disclosure is not limited thereto.

For example, the electronic device 101 may obtain a signal 427 for calling the execution of the first thread 411 during the execution of the second thread 412 during a time period 423-1. The electronic device 101 may release the data set for the second thread 412 from the stack area (e.g., the stack area 310 of FIG. 3) based on obtaining the signal 427 for calling the execution of the first thread 411. After releasing the data set for the second thread 412, the electronic device 101 may identify whether another data set pushed prior to the date set is the data set for the first thread 411 called by the signal 427. In case that the data set for the first thread 411 matches the another data set, the electronic device 101 may execute the first thread 411 through the first cluster 211. When the data set for the first thread 411 does not match the another data set, the electronic device 101 may execute another thread corresponding to the another data set through the first cluster 211. However, the disclosure is not limited thereto.

According to an embodiment, while executing the first thread 411 through the first cluster 211, the electronic device 101 may obtain a signal 446 indicating that execution of the first thread 411 through the first cluster 211 is refrained temporarily. The electronic device 101 may obtain information indicating that the execution of the first thread 411 is refrained through the first cluster 211 based on the process identifier (e.g., the process identifier 305 of FIG. 3). The information may be related to the information 306 of FIG. 3. The information may include an end time point for a boosting operation. However, the disclosure is not limited thereto.

For example, the electronic device 101 may execute at least one thread related to execution of at least one application through the first cluster 211 based on initiating the execution of the at least one application. The electronic device 101 may execute the at least one thread based on designated scheduling information (e.g., scheduling information 254 of FIG. 2) based on identifying that the execution of the at least one application is completed. However, the disclosure is not limited to thereto.

As described above, according to an embodiment, the electronic device 101 may execute the first thread 411 through the first cluster 211 based on obtaining data (e.g., the signal 441) for executing the first thread 411 through a cluster (e.g., the first cluster 211) based on relatively high performance. The electronic device 101 may execute another thread (e.g., the second thread 412 or a third thread 413) related to an event through the first cluster 211 based on identifying the event related to the first thread 411 while executing the first thread 411. The electronic device 101 may reduce time to wait for the first thread 411 based on executing the another thread through the first cluster 211. In order to process the execution of the first thread 411 more quickly, the electronic device 101 may process one or more threads more quickly using one or more clusters 211, 212, and 213 by not only executing the first thread 411 based on the first cluster 211 but also executing other threads related to the first thread 411 through the first cluster 211. The electronic device 101 may maintain an operating of the first cluster 211 by executing other threads 412 and 413 in time periods 421-2, 422-2, and 423-2 related to an event while executing the first thread 411, through the first cluster 211.

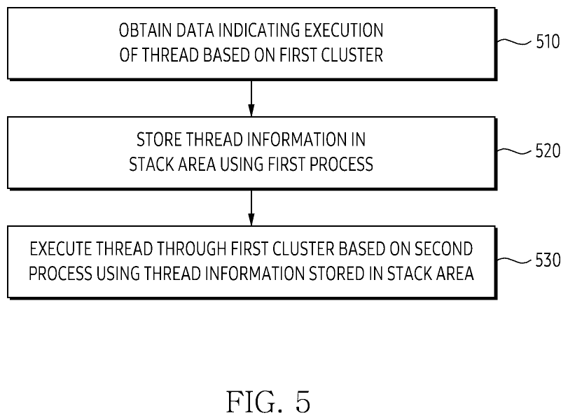

FIG. 5 is a flowchart illustrating an example operation of an electronic device according to various embodiments. An electronic device 101 of FIG. 5 may include the electronic device 101 of FIGS. 1, 2, 3 and 4 (which may be referred to as FIGS. 1 to 4). At least one of operations of FIG. 5 may be performed by the electronic device 101 of FIG. 2 and/or the processor 210 of FIG. 2. Each of the operations of FIG. 5 may be performed sequentially, but is not necessarily performed sequentially. For example, an order of each of the operations may be changed, and at least two operations may be performed in parallel.

Referring to FIG. 5, in operation 510, according to an embodiment, the electronic device may obtain data indicating execution of a thread based on a first cluster. The electronic device may obtain the information 306 of FIG. 3 using the third process 253 of FIG. 2. Based on processing the information 306 using the first process 251 of FIG. 2, the electronic device 101 may obtain data (e.g., the data corresponding to the signal 441 of FIG. 4) indicating the execution of the thread.

Referring to FIG. 5, in operation 520, according to an embodiment, the electronic device may store thread information in a stack area using the first process. For example, the electronic device may store a data set for the thread in the stack area (e.g., the stack area 310 of FIG. 3) based on obtaining the data indicating the execution of the thread. The thread may be more than one.

Referring to FIG. 5, in operation 530, according to an embodiment, an electronic device may execute the thread through the first cluster based on a second process using the thread information stored in the stack area. For example, the stack area may be a kernel area accessible by the second process. The electronic device may migrate the data for the thread from the cluster (e.g., other clusters 212 and 213 distinct from the first cluster 211 of FIG. 2) corresponding to the thread to the first cluster based on the second process. The electronic device may execute the thread using the first cluster based on migrating of the data for the thread.

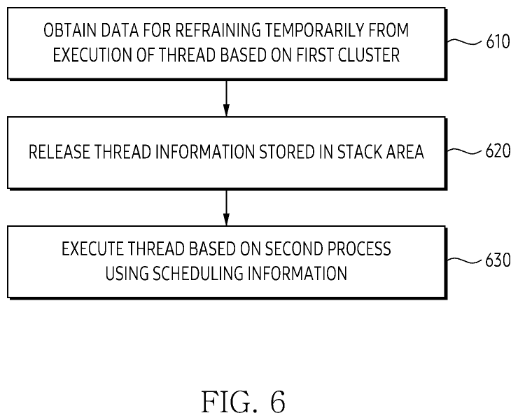

FIG. 6 is a flowchart illustrating an example operation of an electronic device according to various embodiments. An electronic device 101 of FIG. 6 may include the electronic device 101 of FIGS. 1, 2, 3, 4 and 5 (which may be referred to as FIGS. 1 to 5). At least one of operations of FIG. 6 may be performed by the electronic device 101 of FIG. 2 and/or the processor 210 of FIG. 2. At least one of the operations of FIG. 6 may be related to at least one of the operations of FIG. 5. Each of the operations of FIG. 6 may be performed sequentially, but is not necessarily performed sequentially. For example, an order of each of the operations may be changed, and at least two operations may be performed in parallel.

Referring to FIG. 6, in operation 610, according to an embodiment, the electronic device may obtain data for refraining temporarily from execution of a thread based on a first cluster. The data may correspond to the signal 446 of FIG. 4. The electronic device may obtain the data using the third process 253 of FIG. 2.

Referring to FIG. 6, in operation 620, according to an embodiment, the electronic device may release thread information stored in a stack area. The thread information may include the data set for the thread. The electronic device may identify the stack area based on a NULL state by releasing the thread information. The stack area based on the NULL state may refer, for example, to a state in which there is no data set to be processed in the stack area.

Referring to FIG. 6, in operation 630, according to an embodiment, the electronic device may execute the thread based on a second process using scheduling information. The electronic device may execute the thread through a cluster corresponding to the thread using the scheduling information 254 of FIG. 2. However, the disclosure is not limited thereto. The electronic device may terminate the execution of the thread based on obtaining data for refraining temporarily from the execution of the thread based on the first cluster.

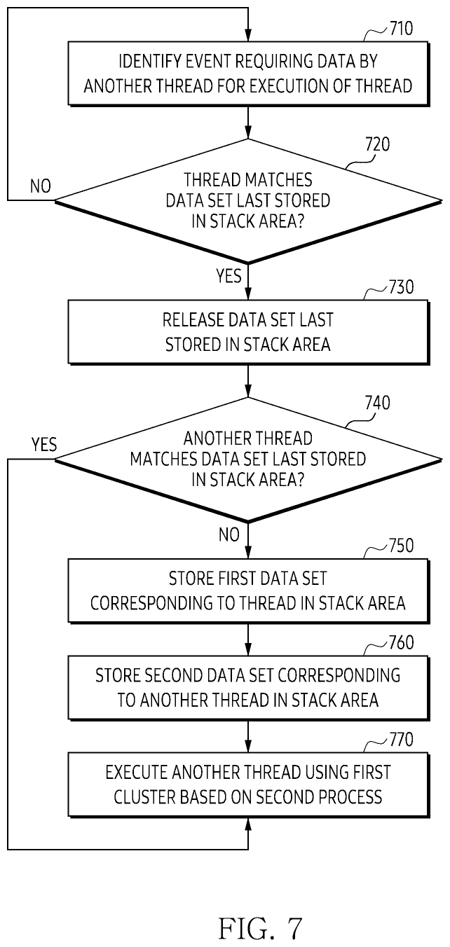

FIG. 7 is a flowchart illustrating an example operation of an electronic device according to various embodiments. An electronic device 101 of FIG. 7 may include the electronic device 101 of FIGS. 1 to 4. At least one of operations of FIG. 7 may be performed by the electronic device 101 of FIG. 2 and/or the processor 210 of FIG. 2. At least one of the operations of FIG. 7 may be related to at least one of the operations of FIG. 5. Each of the operations of FIG. 7 may be performed sequentially, but is not necessarily performed sequentially. For example, an order of each of the operations may be changed, and at least two operations may be performed in parallel.

Referring to FIG. 7, in operation 710, according to an embodiment, the electronic device may identify an event requiring data by another thread for execution of a thread. The operation 710 may be related to the operation 530 of FIG. 5. The event may include a remote procedure call. The electronic device may identify whether the event is related to a first thread (e.g., the first thread 411 of FIG. 4) executed through a first cluster (e.g., the first cluster 211 of FIG. 2). The thread and the other thread may be included in a plurality of threads executed based on a process. The thread and the another thread may or may not be related to threads to be executed based on the first cluster.

Referring to FIG. 7, in operation 720, according to an embodiment, the electronic device may identify whether the thread matches a data set last stored in a stack area. The data set last stored in the stack area may correspond to the first thread (e.g., the first thread 411 of FIG. 4) being executed through the first cluster. The electronic device may identify whether the thread identified by the event matches the first thread. In case that the thread does not match the data set last stored in the stack area (the operation 720—NO), the electronic device may perform the operation 710. In case that the thread and the first thread being executed through the first cluster are different from each other, the electronic device may identify that it is irrelevant to the boosting operation for the first thread.

Referring to FIG. 7, in case that the thread matches the data set last stored in the stack area (the operation 720—YES), in operation 730, according to an embodiment, the electronic device may release the data set last stored in the stack area (e.g., the stack area 310 of FIG. 3). In case that the thread matches the data set last stored in the stack area, the electronic device may refrain temporarily the execution of the first thread corresponding to the data set last stored in the stack area. The electronic device temporarily refraining the execution of the first thread may be referred to an operation in which the electronic device refrains temporarily the execution of the first thread during the time period 443 of FIG. 4.

For example, releasing the data set last stored in the stack area may include initializing the stack area. Based on releasing the data set last stored in the stack area, the operation performed in response to the electronic device obtaining each of the signals 424, 425, 426, and 427 of FIG. 4 may be substantially similar.

Referring to FIG. 7, in operation 740, according to an embodiment, the electronic device may identify whether the another thread matches the data set last stored in the stack area. The data set last stored in the stack area may refer, for example to a data set pushed to the stack area before the data set released in the operation 730. For example, in case that the data set in the operation 730 is the data set stored in the second sub-area 310-2 of FIG. 3, the data set last stored in the stack area in the operation 740 may be the data set stored in the first sub-area 310-1 of FIG. 3. For example, in case that the data set in the operation 730 is the data set stored in the first sub-area 310-1 of FIG. 3, the data set last stored in the stack area in the operation 740 may be a NULL-based data set. However, the disclosure is not limited thereto. For example, in case that the another thread matches the data set last stored in the stack area (the operation 740—YES), the electronic device may perform an operation 770. In case that the another thread matches the data set last stored in the stack area, the electronic device may execute the another thread through the first cluster (e.g., the first cluster 211 of FIG. 2) based on the second process (e.g., the second process 252 of FIG. 2) using the data set for the another thread.

Referring to FIG. 7, in case that the another thread does not match the data set last stored in the stack area (the operation 740—NO), according to an embodiment, in operation 750, the electronic device may store a first data set corresponding to the thread in the stack area. In operation 750, the thread may be referred to the first thread 411 of FIG. 4. The electronic device may push the first data set to the first sub-region (e.g., the first sub-region 310-1 of FIG. 3) of the stack area (e.g., the stack area 310 of FIG. 3) using a first process (e.g., the first process 251 of FIG. 2).

Referring to FIG. 7, in operation 760, according to an embodiment, an electronic device may store a second data set corresponding to the another thread in the stack area. In the operation 760, the another thread may be referred to the second thread 412 of FIG. 4. The electronic device may push the second data set to the second sub-area (e.g., the second sub-area 310-2 of FIG. 3) in a state of pushing the first data set to the first sub-area (e.g., the first sub-area 310-1 of FIG. 3) of the stack area (e.g., the stack area 310 of FIG. 3) using the first process (e.g., the first process 251 of FIG. 2). The electronic device may identify the order of the first data set and the second data set based on the area to which the first data set and the second data set are pushed. The electronic device may process the first data set after processing the second data set based on the order.

Referring to FIG. 7, in operation 770, according to an embodiment, an electronic device may execute the another thread using the first cluster based on the second process. The electronic device may transmit thread information (e.g., the thread information 254 of FIG. 2) including the second data set to the second process 252. The electronic device may execute the another thread through the first cluster (e.g., the first cluster 211 of FIG. 2) based on the second process 252 using the thread information. An operation in which the electronic device executes the another thread using the first cluster based on the second process may be referred to an operation in which the electronic device executes the second thread 412 during the time period 422-1 of FIG. 4. However, the disclosure is not limited thereto. As an example, the operation in which the electronic device executes the another thread using the first cluster based on the second process may be referred to the operation in which the electronic device executes the second thread 412 during the time period 423-1 of FIG. 4.

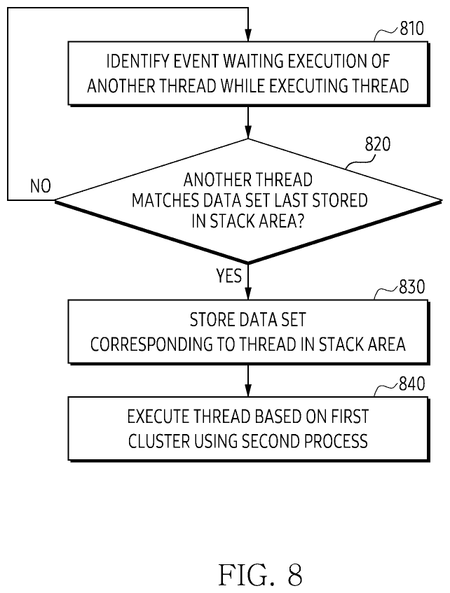

FIG. 8 is a flowchart illustrating an example operation of an electronic device according to various embodiments. The electronic device 101 of FIG. 8 may include the electronic device 101 of FIGS. 1 to 4. At least one of operations of FIG. 8 may be performed by the electronic device 101 of FIG. 2 and/or the processor 210 of FIG. 2. At least one of the operations of FIG. 8 may be related to at least one of the operations of FIG. 5. Each of the operations of FIG. 8 may be performed sequentially, but is not necessarily performed sequentially. For example, the order of each of the operations may be changed, and at least two operations may be performed in parallel.

Referring to FIG. 8, in operation 810, according to an embodiment, the electronic device may identify an event waiting for execution of another thread while executing a thread. The event may be referenced to the event 430 of FIG. 4.

Referring to FIG. 8, in operation 820, according to an embodiment, the electronic device may identify whether the another thread matches a data set last stored in a stack area. The data set last stored in the stack area may correspond to at least one thread being executed through the first cluster (e.g., the first cluster 211 of FIG. 2) based on the second process (e.g., the second process 252 of FIG. 2).

For example, the electronic device may identify whether the event is related to a boosting operation for executing at least one thread based on the first cluster, based on identifying whether the another thread matches the data set last stored in the stack area. In case that the another thread does not match the data set last stored in the stack area (the operation 820—NO), the electronic device may perform the operation 810. The electronic device may identify that the event is irrelevant to the boosting operation when the another thread does not match the data set last stored in the stack area.

Referring to FIG. 8, in case that the another thread matches the data set last stored in the stack area (the operation 820—YES), in operation 830, according to an embodiment, the electronic device may store the data set corresponding to the thread in the stack area. In the operation 830, the another thread may be referred to the first thread 411 of FIG. 4. In operation 830, the thread may be referred to the third thread 413 of FIG. 4. The electronic device may identify that the another thread is executing based on the first cluster 211 in case that the another thread matches the data set last stored in the stack area. The electronic device may refrain temporarily the execution of the another thread in case that the another thread matches the data set last stored in the stack area.

Referring to FIG. 8, in operation 840, according to an embodiment, an electronic device may execute the thread based on the first cluster using the second process. The electronic device may wait for the execution of another thread while executing the thread (e.g., during the time period 442 of FIG. 4). The electronic device may migrate data on the thread from another cluster (e.g., the second cluster 212 of FIG. 2 or the third cluster 213 of FIG. 2) corresponding to the thread to the first cluster to execute the thread based on the first cluster using the second process. However, the disclosure is not limited thereto.

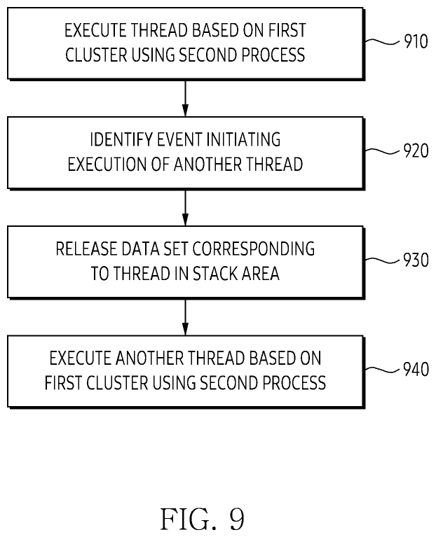

FIG. 9 is a flowchart illustrating an example operation of an electronic device according to various embodiments. An electronic device 101 of FIG. 9 may include the electronic device 101 of FIGS. 1 to 4. At least one of operations of FIG. 9 may be performed by the electronic device 101 of FIG. 2 and/or the processor 210 of FIG. 2. At least one of the operations of FIG. 9 may be related to at least one of the operations of FIG. 8. Each of the operations of FIG. 9 may be performed sequentially, but is not necessarily performed sequentially. For example, an order of each of the operations may be changed, and at least two operations may be performed in parallel.

Referring to FIG. 9, in operation 910, according to an embodiment, an electronic device may execute a thread based on a first cluster using a second process. The operation 910 may correspond to the operation 840 of FIG. 8. The thread may be referred to the third thread 413 of FIG. 4.

Referring to FIG. 9, in operation 920, according to an embodiment, the electronic device may identify an event initiating execution of another thread. The another thread may be referred to the first thread 411 of FIG. 4. The event initiating the execution of the another thread may include an event identifying the signal 435 of FIG. 4 and/or the signal 436 of FIG. 4. The event of initiating the execution of the another thread may include releasing a data range (e.g., a critical period corresponding to the time period 442 of FIG. 4) occupied for the execution of the thread. In case that the data range occupied for the execution of the thread is released, the execution of the another thread waiting to use the data range may be initiated.

Referring to FIG. 9, in operation 930, according to an embodiment, the electronic device may release the data set corresponding to the thread from the stack area. The electronic device may execute the thread through a cluster corresponding to the thread using scheduling information (e.g., the scheduling information 255 of FIG. 2) distinct from thread information (e.g., the thread information 254 of FIG. 2) based on releasing the data set corresponding to the thread in the stack area (e.g., the stack area 310 of FIG. 3).

Referring to FIG. 9, in operation 940, according to an embodiment, an electronic device may execute the another thread based on the first cluster using the second process. Based on releasing the data set corresponding to the thread in the stack area, the electronic device may identify another data set corresponding to the another thread pushed to the stack area prior to the data set corresponding to the thread. The electronic device may transmit the thread information including the another data set to the second process. The electronic device may execute the another thread based on a maximum frequency corresponding to the first cluster using the second process. The electronic device may process data for executing the another thread more quickly based on executing the another thread based on the maximum frequency corresponding to the first cluster.

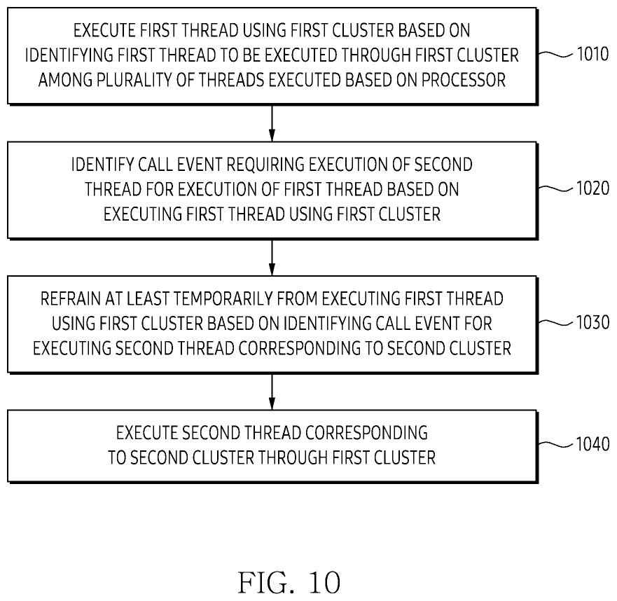

FIG. 10 is a flowchart illustrating an example operation of an electronic device according to various embodiments. An electronic device 101 of FIG. 10 may include the electronic device 101 of FIGS. 1 to 4. At least one of operations of FIG. 10 may be performed by the electronic device 101 of FIG. 2 and/or the processor 210 of FIG. 2. Each of the operations of FIG. 10 may be performed sequentially, but is not necessarily performed sequentially. For example, an order of each of the operations may be changed, and at least two operations may be performed in parallel.

Referring to FIG. 10, in operation 1010, according to an embodiment, the electronic device may execute a first thread using a first cluster based on identifying the first thread (e.g., the first thread 411 of FIG. 4) to be executed through the first cluster (e.g., the first cluster 211 of FIG. 2) among a plurality of threads executed based on a processor (e.g., the processor 210 of FIG. 2). For example, the electronic device may obtain information for executing at least one of the plurality of threads using the first cluster using a first process (e.g., the first process 251 of FIG. 2). The electronic device may transmit the information (e.g., the information 305 of FIG. 3) for executing at least one of the plurality of threads using the first cluster to the first process based on execution of a third process (e.g., the third process 253 of FIG. 2). The electronic device may identify the first thread to be executed using the first cluster based on identifying the information. The electronic device may execute the first thread using the second process (e.g., the second process 252 of FIG. 2) for executing each of the plurality of threads based on at least one of the first cluster or the second cluster based on the information (e.g., the information 306 of FIG. 3) obtained using the first process.

Referring to FIG. 10, in operation 1020, according to an embodiment, the electronic device may identify a call event requiring the execution of a second thread for the execution of the first thread based on executing the first thread using the first cluster. The call event may be identified based on calling the execution of the second thread through the execution of the first thread. The call event may be identified based on using the data for executing the second thread prior to processing data for executing the first thread. The call event may include a remote procedure call and/or a lock event.

Referring to FIG. 10, in operation 1030, according to an embodiment, the electronic device may refrain at least temporarily from executing the first thread using the first cluster based on identifying an event for executing the second thread corresponding to a second cluster. The electronic device may refrain at least temporarily from executing the first thread based on storing a data set indicating the execution of the first thread in the stack area (e.g., the stack area 310 of FIG. 3) of memory assigned to the first process.

Referring to FIG. 10, in operation 1040, according to an embodiment, the electronic device may execute the second thread (e.g., the second thread 412 of FIG. 4 or the third thread 413 of FIG. 4) corresponding to the second cluster (e.g., the second cluster 212 of FIG. 2 or the third cluster 213 of FIG. 2) through the first cluster. The electronic device may execute the second thread using thread information (e.g., the thread information 254 of FIG. 2) independently of executing the second thread using scheduling information (e.g., the scheduling information 255 of FIG. 2).

For example, based on executing the second thread through the first cluster, the electronic device may identify another event for executing a third thread that is distinct from the second thread among the plurality of threads. The another event may refer, for example, to a binder call. The another event may refer, for example, to an event of calling the third thread using the second thread after identifying the event. The electronic device may identify the another event based on execution of a binder driver for identifying the binder call. For example, based on identifying the another event, using the first process, the electronic device may identify whether the third thread is identical to the first thread indicated by the data set. The electronic device may identify whether the third thread and the first thread match using the data set corresponding to the first thread pushed to the stack area (e.g., the stack area 310 of FIG. 3). For example, the electronic device may refrain at least temporarily from executing the second thread in a state where the third thread and the first thread are identical. For example, the electronic device may identify whether the third thread and the first thread match based on releasing the data set for the second thread in the stack area. However, the disclosure is not limited thereto. The electronic device may execute the first thread through the first cluster based on refraining at least temporarily from executing the second thread. For example, the electronic device may store another data set indicating the execution of the third thread in the stack area in another state distinct from the state. The electronic device may execute the third thread through the first cluster based on the second process using the another data set. However, the disclosure is not limited thereto.

According to an embodiment, the electronic device may identify an event between a thread and another thread to execute the thread using a cluster corresponding to a relatively high frequency among a plurality of clusters. The electronic device may execute at least one of the thread and the another thread using the cluster based on identifying the event. A method for identifying a thread related to an event by the electronic device may be required.

As described above, according to an example embodiment, in an electronic device, the electronic device may comprise: memory comprising one or more storage media storing instructions, and at least one processor comprising a first cluster including one or more cores operating in a first frequency range, and a second cluster including one or more cores having a maximum frequency less than a maximum frequency of the first frequency range, wherein at least one processor, individually or collectively, may be configured to execute the instructions and to cause the electronic device to: based on identifying a first thread to be executed through the first cluster among a plurality of threads executed based on the processor, execute the first thread using the first cluster; based on executing the first thread using the first cluster, identify a call event requiring execution of a second thread for executing the first thread; based on identifying the call event for executing the second thread corresponding to the second cluster, refrain at least temporarily from executing the first thread using the first cluster; and execute the second thread corresponding to the second cluster through the first cluster.

For example, for identifying the first thread, at least one processor individually or collectively, may be configured to cause the electronic device to, based on obtaining, using a first process, information for executing, using the first cluster, at least one of the plurality of threads, identify the first thread.

For example, for executing the first thread, at least one processor individually or collectively, may be configured to cause the electronic device to execute, based on information obtained using the first process, the first thread using a second process for executing, based on at least one of the first cluster or the second cluster, each of the plurality of threads.

For example, for refraining at least temporarily from executing the first thread, at least one processor individually or collectively, may be configured to cause the electronic device to refrain at least temporarily from executing the first thread based on storing, in a stack area of the memory assigned to the first process, a data set indicating execution of the first thread.

For example, at least one processor individually or collectively, may be configured to cause the electronic device to: based on executing the second thread through the first cluster, identify another call event for executing a third thread among the plurality of threads that is distinct from the second thread; based on identifying the another call event, identify, using the first process, whether the third thread is identical to the first thread indicated by the data set; refrain at least temporarily from executing the second thread during a state where the third thread and the first thread are identical; and execute the first thread through the first cluster.

For example, at least one processor individually or collectively, may be configured to cause the electronic device to: in another state distinct from the state, store, in the stack area, another data set indicating execution of the third thread; and execute, based on the second process using the another data set, the third thread through the first cluster.

For example, the call event may be identified based on calling the execution of the second thread through the execution of the first thread.

For example, the call event may be identified based on the data being used for execution of the second thread before processing the data for execution of the first thread.

For example, at least one processor individually or collectively, may be configured to cause the electronic device to: identify the call event indicating that the second thread occupies with regard to the data for executing the first thread; while identifying the call event indicating that the second thread occupies the data, refrain at least temporarily from executing operations requiring access to the data by the first thread using the first cluster, and execute operations requiring access to the data among the operations of the second thread corresponding to the second cluster through the first cluster.

As described above, in an example method performed by an electronic device according to example embodiment, the method may comprise: based on identifying a first thread to be executed through a first cluster among a plurality of threads executed based on a processor, executing the first thread using the first cluster; based on executing the first thread using the first cluster, identifying a call event requiring execution of a second thread for executing the first thread; based on identifying the call event for executing the second thread corresponding to a second cluster, refraining at least temporarily from executing the first thread using the first cluster; and executing the second thread corresponding to the second cluster through the first cluster.

For example, identifying the first thread may comprise, based on obtaining, using a first process, information for executing, using the first cluster, at least one of the plurality of threads, identifying the first thread.

For example, executing the first thread may comprise executing, based on information obtained using the first process, the first thread using a second process for executing, based on at least one of the first cluster or the second cluster, each of the plurality of threads.

For example, refraining at least temporarily from executing the first thread may comprise refraining at least temporarily from executing the first thread based on storing, in a stack area of memory assigned to the first process, a data set indicating execution of the first thread.

For example, the method may comprise: based on executing the second thread through the first cluster, identifying another call event for executing a third thread among the plurality of threads that is distinct from the second thread; based on identifying the another call event, identifying, using the first process, whether the third thread is identical to the first thread indicated by the data set; refraining at least temporarily from executing the second thread during a state where the third thread and the first thread are identical; and executing the first thread through the first cluster.

For example, identifying whether it is identical to the first thread may comprise, in another state distinct from the state, storing, in the stack area, another data set indicating execution of the second thread. Identifying whether it is identical to the first thread may comprise executing, based on the second process using the another data set, the third thread through the first cluster.

For example, the call event may be identified based on calling the execution of the second thread through the execution of the first thread.

For example, the call event may be identified based on the data being used for execution of the second thread before processing the data for execution of the first thread.

In a non-transitory computer-readable storage medium storing one or more programs according to an example embodiment as described above, the one or more programs may include instructions which, when executed by at least one processor including processing circuitry of an electronic device individually or collectively, cause the electronic device to: based on identifying a first thread to be executed through a first cluster among a plurality of threads executed based on the processor, execute the first thread using the first cluster; based on executing the first thread using the first cluster, identify a call event requiring execution of a second thread for executing the first thread; based on identifying the call event for executing the second thread corresponding to a second cluster, refrain at least temporarily from executing the first thread using the first cluster; and execute the second thread corresponding to the second cluster through the first cluster.

For example, for identifying the first thread, the one or more programs may include instructions which, when executed by the at least one processor of the electronic device individually or collectively, cause the electronic device to, based on obtaining, using a first process, information for executing, using the first cluster, at least one of the plurality of threads, identify the first thread.

For example, for executing the first thread, the one or more programs may include instructions which, when executed by the at least one processor of the electronic device individually or collectively, cause the electronic device to, based on information obtained using the first process, execute the first thread using a second process for executing, based on at least one of the first cluster or the second cluster, each of the plurality of threads.

For example, for refraining at least temporarily from executing the first thread, the one or more programs may include instructions which, when executed by the at least one processor of the electronic device individually or collectively, cause the electronic device to, refrain at least temporarily from executing the first thread based on storing, in a stack area of the memory assigned to the first process, a data set indicating execution of the first thread.

The device described above may be implemented as a hardware component, a software component, and/or a combination of a hardware component and a software component. For example, the devices and components described in the various embodiments may be implemented using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but it may be apparent to one of ordinary skill in the relevant technical field that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to an embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

Although the example embodiments have been described above with reference to limited examples and drawings, various modifications and variations may be made from the above description by those skilled in the art. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, and those equivalent to the scope of the claims are included in the scope of the disclosure.

What is claimed is:

1. An electronic device comprising:
memory comprising one or more storage media storing instructions,
at least one processor, comprising processing circuitry, and comprising a first cluster including one or more cores operating in a first frequency range, and a second cluster including one or more cores having a maximum frequency less than a maximum frequency of the first frequency range,
wherein at least one processor, individually or collectively, is configured to execute the instructions and to cause the electronic device to:
based on identifying a first thread to be executed through the first cluster among a plurality of threads executed based on the at least one processor, execute the first thread using the first cluster,
based on executing the first thread using the first cluster, identify a call event requiring execution of a second thread for executing the first thread; and
based on identifying the call event for executing the second thread corresponding to the second cluster:
refrain at least temporarily from executing the first thread using the first cluster, and
execute the second thread corresponding to the second cluster through the first cluster.

2. The electronic device of claim 1,
wherein, for identifying the first thread, at least one processor individually or collectively, is configured to cause the electronic device to:
based on obtaining, using a first process, information for executing, using the first cluster, at least one of the plurality of threads, identify the first thread.

3. The electronic device of claim 1,
wherein, for identifying the first thread, at least one processor individually or collectively, is configured to cause the electronic device to:
execute, based on information obtained using the first process, the first thread using a second process for executing, based on at least one of the first cluster or the second cluster, each of the plurality of threads.

4. The electronic device of claim 2,
wherein, for refraining at least temporarily from executing the first thread, at least one processor individually or collectively, is configured to cause the electronic device to:
refrain at least temporarily from executing the first thread based on storing, in a stack area of the memory assigned to the first process, a data set indicating execution of the first thread.

5. The electronic device of claim 4,
wherein at least one processor individually or collectively, is configured to cause the electronic device to:
based on executing the second thread through the first cluster, identify another call event for executing a third thread among the plurality of threads distinct from the second thread,
based on identifying the another call event, identify, using the first process, whether the third thread is identical to the first thread indicated by the data set, and
refrain at least temporarily from executing the second thread during a state where the third thread and the first thread are identical, and
execute the first thread through the first cluster.

6. The electronic device of claim 5,
wherein at least one processor individually or collectively, is configured to cause the electronic device to:
in another state distinct from the state, store, in the stack area, another data set indicating execution of the third thread, and
execute, based on the second process using the another data set, the third thread through the first cluster.

7. The electronic device of claim 1,
wherein the call event is identified based on calling the execution of the second thread through the execution of the first thread.

8. The electronic device of claim 1,
wherein the call event is identified based on the data being used for execution of the second thread before processing the data for execution of the first thread.

9. The electronic device of claim 1,
wherein at least one processor individually or collectively, is configured to cause the electronic device to:
identify the call event indicating that the second thread occupies with regard to the data for executing the first thread,
while identifying the call event indicating that the second thread occupies the data:
refrain at least temporarily from executing operations requiring access to the data by the first thread using the first cluster,
execute operations requiring access to the data among the operations of the second thread corresponding to the second cluster through the first cluster.

10. A method performed by an electronic device, comprising:
based on identifying a first thread to be executed through a first cluster among a plurality of threads executed based on a processor, executing the first thread using the first cluster,
based on executing the first thread using the first cluster, identifying a call event requiring execution of a second thread for executing the first thread; and
based on identifying the call event for executing the second thread corresponding to a second cluster:
refraining at least temporarily from executing the first thread using the first cluster, and
executing the second thread corresponding to the second cluster through the first cluster.

11. The method of claim 10,
wherein identifying the first thread comprises:
based on obtaining, using a first process, information for executing, using the first cluster, at least one of the plurality of threads, identifying the first thread.

12. The method of claim 11,
wherein executing the first thread comprises:
executing, based on information obtained using the first process, the first thread using a second process for executing, based on at least one of the first cluster or the second cluster, each of the plurality of threads.

13. The method of claim 11,
wherein refraining at least temporarily from executing the first thread comprises:
refraining at least temporarily from executing the first thread based on storing, in a stack area of memory assigned to the first process, a data set indicating execution of the first thread.

14. The method of claim 13, comprising:
based on executing the second thread through the first cluster, identifying another call event for executing a third thread among the plurality of threads distinct from the second thread,
based on identifying the another call event, identifying, using the first process, whether the third thread is identical to the first thread indicated by the data set, and
refraining at least temporarily from executing the second thread during a state where the third thread and the first thread are identical, and
executing the first thread through the first cluster.

15. The method of claim 14, comprising:
in another state distinct from the state, storing, in the stack area, another data set indicating execution of the third thread, and
executing, based on the second process using the another data set, the third thread through the first cluster.

16. The method of claim 10,
wherein the call event is identified based on calling the execution of the second thread through the execution of the first thread.

17. The method of claim 10,
wherein the call event is identified based on the data being used for execution of the second thread before processing the data for execution of the first thread.

18. The method of claim 10, comprising:
identifying the call event indicating that the second thread occupies with regard to the data for executing the first thread,
while identifying the call event indicating that the second thread occupies the data:
refraining at least temporarily from executing operations requiring access to the data by the first thread using the first cluster,
executing operations requiring access to the data among the operations of the second thread corresponding to the second cluster through the first cluster.

19. A non-transitory computer-readable storage medium, comprising
one or more programs including instructions,
wherein the instructions, when executed by at least one processor of an electronic device, individually or collectively, cause the electronic device to:
based on identifying a first thread to be executed through a first cluster among a plurality of threads executed based on the at least one processor, execute the first thread using the first cluster,
based on executing the first thread using the first cluster, identify a call event requiring execution of a second thread for executing the first thread; and
based on identifying the call event for executing the second thread corresponding to a second cluster:
refrain at least temporarily from executing the first thread using the first cluster, and execute the second thread corresponding to the second cluster through the first cluster.

20. The non-transitory computer-readable storage medium of claim 19,
wherein the instructions, when executed by at least one processor, individually or collectively, cause the electronic device to:
based on obtaining, using a first process, information for executing, using the first cluster, at least one of the plurality of threads, identify the first thread.
